(19) United States
(12) Patent Application Publication
(10) Pub. No.: US 2024/0270645 A1
(43) Pub. Date: Aug. 15, 2024

(54) HYDROPHOBIC FUNCTIONALIZATION OF SILICEOUS MATERIAL WITH BIO-OILS

(71) Applicants: Elham Fini, Phoenix, AZ (US); Albert Hung, Tempe, AZ (US)

(72) Inventors: Elham Fini, Phoenix, AZ (US); Albert Hung, Tempe, AZ (US)

(21) Appl. No.: 18/442,675

(22) Filed: Feb. 15, 2024

Related U.S. Application Data
(60) Provisional application No. 63/485,123, filed on Feb. 15, 2023.

(51) Int. Cl. C04B 20/10; C04B 20/04; C04B 103/00

(52) U.S. Cl. CPC C04B 20/1037; C04B 20/04; C04B 2103/0052

(57) ABSTRACT

Modifying siliceous material includes combining siliceous material and bio-oil to yield a mixture, and polymerizing the bio-oil in the mixture to yield hydrophobic siliceous material, wherein a hydrophobicity of the hydrophobic siliceous material exceeds a hydrophobicity of the siliceous material. The resulting composition includes a multiplicity of hydrophobic particles, wherein each hydrophobic particle comprises a polymeric bio-oil-derived coating on a core comprising siliceous material, and a hydrophobicity of the polymeric bio-oil-derived coating exceeds a hydrophobicity of the corresponding core.

### CROSS-REFERENCE TO RELATED APPLICATION

This application claims the benefit of U.S. Patent Application No. 63/485,123 filed on Feb. 15, 2023, which is incorporated herein by reference in its entirety.

### STATEMENT OF GOVERNMENT SUPPORT

This invention was made with government support under grant number 1928795 awarded by the National Science Foundation. The government has certain rights in the invention.

### TECHNICAL FIELD

This invention relates to methods of making hydrophobic siliceous material using bio-oils, as well as the resulting hydrophobic siliceous material.

### BACKGROUND

Inorganic oxide fillers are used in manufacturing and construction industries as additives to increase strength and durability. In one example, silica fume—an amorphous polymorph of silicon dioxide with average particle diameter of 150 nm—can be added to cement concrete to improve its compressive strength, bond strength, and abrasion resistance.

### SUMMARY

This disclosure describes methods of making hydrophobic siliceous material using environmentally safe bio-oils, as well as the resulting hydrophobic siliceous material. As used herein, “siliceous material” generally refers to material that includes at least 10 wt % silica, such as glass fibers, glass beads, glass powders, mineral fume, nano silica, clay, quartz, granite, sand, and sandstone. The glass materials (e.g., glass beads, glass powders) can be pristine, recycled, or reclaimed. As used herein, “mineral fume” generally refers to a powder including one or more components, at least one of which is an inorganic oxide. One example of a mineral fume is silica fume. Additional examples of mineral fumes include other siliceous materials such as Nat or Ca⁺ clay, glass, slag, bottom ash, incineration ash, fly ash, mine tailing, as well as metal oxides such as alumina and iron oxide.

Methods of making hydrophobic siliceous material include combining bio-oil with siliceous material to yield a mixture, and heating the mixture to polymerize the bio-oil. The bio-oil can be an edible or non-edible refined oil from plant, animal, or waste sources (e.g., waste vegetable oil). Components of the bio-oil have allylic functional groups. Polymerization of the bio-oil occurs by a mechanism involving hydrogen atom abstraction from allylic carbons in the presence of oxygen. The polymerization reaction cross-links the bio-oil. The polymerized bio-oil adsorbs to the surface of the siliceous material. After the polymerization reaction, excess bio-oil is removed by solvent washing, centrifugation, or other processes. The methods described herein result in a hydrophobic coating of the polymerized bio-oil chemisorbed or physisorbed on the surface of the siliceous material. Hydrophobicity is demonstrated by contact angle tests in which surfaces coated with the hydrophobic siliceous material exhibit hydrophobic water beading effects.

In a first general aspect, modifying siliceous material includes combining siliceous material and bio-oil to yield a mixture; and polymerizing the bio-oil in the mixture to yield hydrophobic siliccous material, wherein a hydrophobicity of the hydrophobic siliceous material exceeds a hydrophobicity of the siliceous material.

Implementations of the first general aspect may include one or more of the following features.

Combining the siliceous material and the bio-oil to yield the mixture can include scaling the mixture and an oxygen-containing gas in a container. Polymerizing the bio-oil can include heating the mixture in a temperature range of 150° C. to 200° ° C. (e.g., for a length of time from 1 minute to 1 hour). Some implementations include separating the hydrophobic siliccous material and excess bio-oil. Certain implementations include contacting the siliccous material with acid (e.g., carbonic acid) or supercritical carbon dioxide before combining the siliceous material and the bio-oil to yield the mixture. Certain implementations include combining Fe₃O₄ with the mixture before polymerizing the bio-oil.

In a second general aspect, the composition resulting from the method of the first general aspect includes a multiplicity of hydrophobic particles, wherein each hydrophobic particle comprises a polymeric bio-oil-derived coating on a core comprising siliceous material, and a hydrophobicity of the polymeric bio-oil-derived coating exceeds a hydrophobicity of the corresponding core.

Implementations of the first and second general aspects may include one or more of the following features.

The siliceous material typically includes at least 10 wt % silica. Examples of siliceous material include glass fibers, glass beads, glass powders, mineral fume, nano silica, clay, quartz, granite, sand, sandstone, or any combination thereof. Examples of mineral fume include Na⁺ clay, Ca⁺ clay, glass, slag, bottom ash, incineration ash, fly ash, mine tailing, metal oxides, or any combination thereof. Examples of metal oxides include alumina and iron oxide.

The bio-oil includes oil from animal sources, plant sources, or both. The bio-oil typically includes one or more allylic functional groups. An iodine value of the bio-oil is typically in a range of 6 to 200. Examples of bio-oils include linseed oil, olive oil, coconut oil, vegetable oil, or any combination thereof. In one example, the bio-oil is a waste vegetable oil.

The hydrophobic siliceous material can be used as in composites for anti-caking, adsorption/filtration, and other applications. These materials can also be used as additives (e.g., a filler) in manufacturing and construction industries to increase strength and durability of materials. In one example, hydrophobic silica fume is added to cement/concrete to improve its compressive strength, bond strength, and abrasion resistance. The hydrophobicity of the hydrophobic siliceous material filler facilitates dispersion and compatibility of the particles with other constituents in cement/concrete mixtures.

Methods of making hydrophobic siliceous material described herein provide a low-cost, non-silane based method of functionalizing the surface of siliceous material to be hydrophobic using renewable and environmentally safe bio-oils.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1 shows contact angle as a function of hydrolysis temperature for glass microscope slides treated with coconut oil, linseed oil, and waste vegetable oil.

FIG. 2 shows change in intensity of the cis-ethylene CH stretching peak at 3008 cm⁻¹ as a function of time for waste vegetable oil polymerized in open air, covered, and covered with Si-rich fume.

### DETAILED DESCRIPTION

This disclosure describes methods of making hydrophobic siliceous material using environmentally safe bio-oils. The method includes combining siliceous material with bio-oil to yield a mixture, and polymerizing the bio-oil to yield the hydrophobic siliceous material. As used herein, “siliceous material” generally refers to material that includes at least 10 wt % silica, such as glass fibers, glass beads, glass powders, mineral fume, nano silica, clay, quartz, granite, sand, and sandstone. The glass materials (e.g., glass beads, glass powders) can be pristine, recycled, or reclaimed. As used herein, “mineral fume” generally refers to a powder including one or more components, at least one of which is an inorganic oxide. One example of a mineral fume is silica fume. Additional examples of mineral fumes include other siliceous materials such as Na⁺ or Ca⁺ clay, glass, slag, bottom ash, incineration ash, fly ash, mine tailing, as well as metal oxides such as alumina and iron oxide. The polymerized bio-oil adsorbs to the surface of the siliceous material particles. The coating of polymerized bio-oil increases the hydrophobicity of the siliceous material and facilitates its use a filler to increase the strength and durability of a variety of construction and manufacturing materials (e.g., cement or concrete).

Suitable bio-oils include oil from animal sources, plant sources, or both, and typically have one or more allylic functional groups. Examples of suitable bio-oils include linseed oil, olive oil, coconut oil, and vegetable oil. The bio-oil can include waste oil, such as waste vegetable oil. “Drying” oils, like linseed oil, are often used in oil paints, linoleum, and wood finish. These oils polymerize via hydrogen abstraction from allylic carbons and reaction with O₂. Waste vegetable oil (e.g., from restaurants), an inexpensive alternative, is not a traditional “drying” oil, but starts cross-linking above the smoke point (e.g., 200° C.).

Polymerization of the bio-oil and adsorption to the surface of the siliceous material particles can be initiated by hydrogen atom abstraction from bio-oil allylic carbons in the presence of oxygen to yield a delocalized radical species. The radical reaction then leads to polymerized and cross-linked bio-oil, which adsorbs to the surface of the siliceous material particles and forms a hydrophobic coating. In one example, the polymerization reaction includes heating the mixture of bio-oil and siliceous material in a temperature range of 150° C. to 200° C. for a length of time from 1 minute to 1 hour. The mixture can be heated in a sealed container including oxygen gas, thus providing the reaction with a limited amount of oxygen. Following the reaction, the hydrophobic siliceous material and the excess bio-oil can be separated.

Methods described herein can be modified to increase the hydrophobicity of the hydrophobic siliceous material. In one such example, the siliceous material includes MgO. During the polymerization reaction, MgO reacts to yield Mg(OH)₂, which can cleave bio-oil esters to yield hydrophilic fatty acids salts. To minimize the production of fatty acid salts, the siliceous material can be contacted with acid before combining with the bio-oil. Other methods to reduce or minimize the production of fatty acid salts include contacting the siliceous material with carbonic acid or supercritical carbon dioxide before combining the siliceous material with the bio-oil. In one example, the bio-oil and siliceous material are combined with Fe₃O₄ before polymerizing the bio-oil to increase the hydrophobicity of the hydrophobic siliceous material.

### EXAMPLES

### Example 1

Silica fume with varying silica and iron wt % content was obtained from Norchem. The contents of Si-rich and Fe-rich silica fume are provided in Table 1.

TABLE 1
Silica fume content

| | Norchem silica fume (wt %) | |
|---|---|---|
| | Si-rich | Fe-rich |
| SiO₂ | 93.69 | 78.09 |
| C | 3.71 | 3.72 |
| Fe₂O₃ | 0.14 | 6.50 |
| MgO | 0.18 | 8.54 |

Bio-oils used to modify the silica fume included linseed, olive, coconut, and waste vegetable oil (WVO). Because iodine is reactive to unsaturated bonds, the allylic content of the bio-oils can be characterized using the measured iodine value. The iodine value is defined as the mass of iodine in grams that is consumed by 100 grams of material. The measured iodine values for the bio-oils used in this disclosure are given in Table 2.

TABLE 2
Iodine values for bio-oils

| Bio-oil | Iodine Value |
|---|---|
| Linseed | 170-200 |
| Olive | 75-90 |
| Coconut | 6-11 |
| Waste Vegetable Oil | 50-100 |

In an example of the method used to make hydrophobic siliceous material, 200 mg of the silica fume were combined with 2 mL of the bio-oil and sealed in a microwave reactor. The reactor was sealed under atmospheric conditions to provide a limited amount of oxygen during the polymerization reaction. The mixture was heated to 200° C. for 30 minutes. The reacted mixture was then washed and centrifuged three times to remove excess bio-oil.

Attenuated total reflectance Fourier transform infrared (ATR-FTIR) spectra of SiOx fume containing 95% silica and 75% silica modified with waste vegetable oil were obtained. The 75% silica sample contains a higher percentage of both Fe₂O₃ and MgO than the 95% silica sample as observed in Table 1. The ATR-FTIR spectra indicate more alkanes in the 75% silica (Fe-rich) than in the 95% silica (Si-rich) sample, but also more carboxylate salt (COO⁻). The presence of the carboxylate salt decreases the hydrophobicity of the Fe-rich sample, as indicated by contact angle experiments. The modified 75% silica (Fe-rich) coating exhibits significantly less hydrophobicity than the superhydrophobic 95% silica (Si-rich) coating as indicated by the lower contact angle of the droplet on the Fe-rich coated slide.

Referring to Table 1, the Fe-rich silica fume sample contains approximately 47 times more MgO than the Si-rich silica fume sample. During the polymerization reaction, MgO can react to become Mg(OH)₂ and cleave bio-oil esters to make fatty acid salts (e.g., [Mg²⁺][R—COO⁻]₂). These fatty acid salts decrease the hydrophobicity of the hydrophobic silica fume particles. To minimize the formation of these fatty acid salts, the Fe-rich silica fume can first be washed with acid (e.g., HCl) before the polymerization reaction is carried out. This acid pre-wash allows for more complete hydrophobic functionalization. ATR-FTIR spectra of SiOx fume containing 95% silica and HCl washed 75% silica modified with waste vegetable oil were obtained. The observed attenuation of the COO⁻ at approximately 1600 cm⁻¹ in the acid washed sample indicates a significant reduction in the presence of the hydrophilic fatty acid salts. A contact angle experiment of acid washed Fe-rich SiOx fume modified with waste vegetable oil showed significantly more hydrophobicity when compared to the unwashed modified Fe-rich sample.

As an alternative to acid washing the Fe-rich silica fume, the MgO may be converted to MgCO₃ using carbonic acid or supercritical CO₂. When supercritical CO₂ is used, the estimated capture is 0.1 ton of CO₂ per ton of Fe-rich silica fume.

Tests were conducted to determine the effects of polymerization time, polymerization temperature, and number of solvent rinses on the presence of unreacted bio-oil following the polymerization reaction. The alkane peak region of FTIR spectra for 95% silica fume modified with WVO for a 10 minute polymerization time at temperatures of 150° C., 200° C., and 250° C., with 2 and 4 solvent rinses were observed. The silica fume showed modification by the WVO even with this relatively short (10 minute) reaction time. The modification was reduced at 150° C., but comparable results were achieved at 200° ° C. and 250° C. The spectra indicate that 3-4 cycles of solvent rinsing and centrifugation were sufficient to remove an acceptable amount of excess bio-oil.

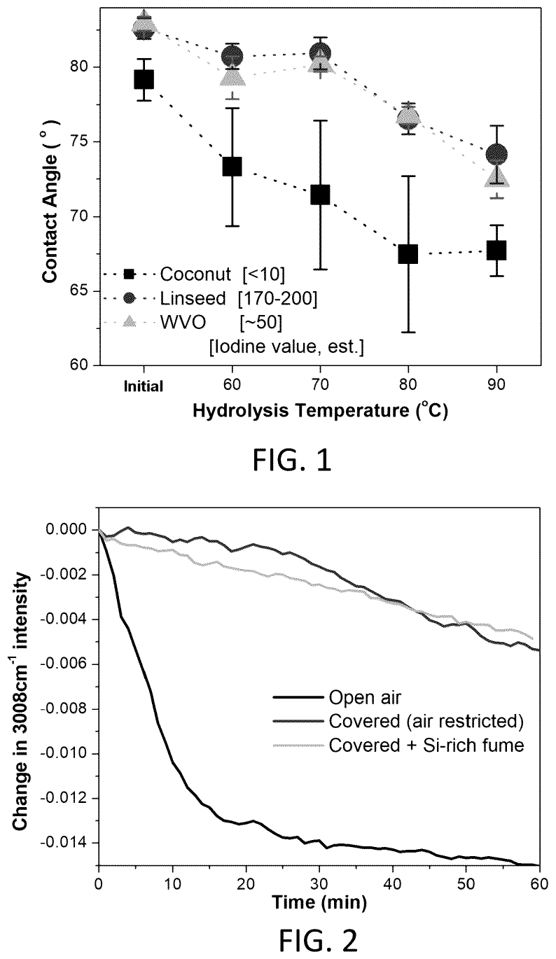

The resistance of different bio-oils to hydrolysis as a function of temperature was analyzed. The contact angle of the bio-oils coated on glass slides was measured after immersion for 5 minutes in water held at 50° C. to 90° C. The results are shown in FIG. 1. The resistance to hydrolysis of linseed oil and WVO were comparable. Even though coconut oil has a relatively low iodine value, the results show that physisorbed coconut oil exhibited some hydrophobic effect but is less stable than the oils with the higher iodine values.

ATR-FTIR spectra of SiOx fume including 95% silica modified with waste vegetable oil, pre-baked at 170° C. for one hour, and with the addition of 5 wt % Fe₃O₄ 50 nm powder were obtained. The similarity of the peaks in the alkane region for the as-is and the pre-baked samples indicate that pre-baking the silica fume to remove adsorbed water prior to the polymerization reaction has little effect on the extent of the polymerization reaction. However, the addition of Fe₃O₄ to the polymerization reaction mixture produced an increase in baseline absorbance. This increase indicates that Fe-based catalysts may promote surface modification through carbonation reactions and thus increase the degree of hydrophobicity of the modified silica fume.

A variety of siliceous materials can be used for making hydrophobic mineral fume. ATR-FTIR spectra of Al₂O₃ and Na⁺ montmorillonite modified with waste vegetable oil were obtained. The spectra indicate significant covalent modification of the Na montmorillonite. However, the Al₂O₃ sample (3 μm alumina powder) shows little alkane modification. This may be due to the smaller surface area available in the alumina sample compared with other mineral samples, or it could be due to less covalent modification in the polymerization reaction. It is likely that the bio-oil is primarily physisorbed rather than chemisorbed to the surface of the Al₂O₃ particles. However, contact angle tests indicate that both the modified Na montmorillonite and Al₂O₃ samples, respectively, exhibit significant hydrophobicity.

Tests were conducted to monitor the extent of the polymerization reaction in real time under a variety of conditions using an ATR-FTIR instrument equipped with a heated stage. ATR-FTIR spectra of waste vegetable oil alone polymerized in open air at 200° C. from 2 minutes to 58 minutes were obtained. The spectra obtained of the reaction carried out in an open reactor show rapid consumption of C═C bonds and an accelerated formation of C═O and C—O groups relative to the reaction taking place in a sealed reactor. Thus, having atmospheric O₂ constantly available during the polymerization reaction accelerates the cross-linking reaction but produces a more hydrophilic coating on the particles by increasing the formation of C═O and C—O. For both WVO alone and WVO with Si-rich fume, respectively, in sealed reactors, the cross-linking reaction is slower but with less production of C—O and C—O groups compared with the reaction having constantly available atmospheric O₂ in an open reactor. Thus, sealing the reaction vessel and limiting the oxygen supply during the polymerization reaction produces a more hydrophobic product.

Changes in ATR-FTIR spectra monitored in real time during the polymerization reaction can be more readily observed in difference spectra. The plots were obtained by subtracting a time=0 spectrum from spectra obtained at time=2 minutes to 58 minutes. ATR-FTIR difference spectra of waste vegetable oil polymerized in a closed container at 200° ° C. from 2 minutes to 58 minutes were obtained. A decrease in intensity of peaks associated with C═C bonds and an increase in intensity of peaks associated with C—O and C—O groups is evident. Also observable is an increase in peak intensity corresponding to trans C═C bonds, indicating isomerization, and a slight increase in peak intensity corresponding to CH₃, indicating scission.

ATR-FTIR difference spectra of waste vegetable oil with Si-rich fume polymerized in a closed container at 200° C. from 2 minutes to 58 minutes were obtained. These spectra show many of the same spectral changes that were observed for WVO polymerized in a closed container without silica fume. Subtle differences in the spectra may indicate aromatic ring formation or covalent bonding to the silica surface (e.g., Si—O—C bonding).

FIG. 2 shows plots of the change in intensity of the 3008 cm⁻¹ ATR-FTIR peak as a function of time for waste vegetable oil polymerized in open air (lower plot), in a sealed (covered) container (upper plot), and in a sealed (covered) container with Si-rich fume (middle plot). The 3008 cm⁻¹ peak reports on the presence of C═C bonds. The C═C bonds may be consumed by oxidation or by polymerization reactions. Having constantly available atmospheric oxygen in an open container rapidly consumes the C═C bonds at 200° C. The reaction of WVO in the absence of silica fume in a sealed container appears to have an induction time before proceeding. The reaction of WVO in a sealed container in the presence of silica fume shows a more consistent reaction rate than observed for the other two conditions, possibly due to a catalytic effect of the silica fume.

### Example 2

Waste vegetable oil (WVO) was obtained from a third-party source that collected used cooking oil from food establishments and filtered out any solid particulates. The silica fume acquired from Norchem was a by-product of ferro-silicon alloy production and came in two batches distinguished by silica content: fume with roughly 95% silica (“Si-rich”) and fume with roughly 75% silica (“Fe-rich”). Table 1 shows the chemical composition of both batches highlighting key majority constituents. Acetone and ethanol for cleaning were obtained from Fisher Scientific.

In a typical procedure for modifying powder samples, 200 mg of solid powder and 2 mL of WVO are mixed in a reaction vessel and placed in a CEM Discover 2.0 microwave reactor. The mixture is heated at 200° ° C. with magnetic stirring for 30 min. After cooling down, the mixture is centrifuged and the majority of the oil is decanted. The modified solid was then washed by mixing with 8 mL of solvent followed by centrifugation and decanting the solvent. This washing cycle was performed twice with acetone and then once with ethanol. The modified solid was dried under light vacuum before characterization. Variations on this procedure were tested including different reaction temperatures (150, 200, or 250° C.), number of acetone washing cycles (1-3), and plant oils (coconut or linseed).

For modification of large objects like microscope slide glass, the slides were cut down into 1″×0.5″ pieces that could fit into the reaction vessel, and the same basic reaction conditions were used. To wash the modified glass, the pieces were removed from the oil and sonicated for 1 min each in acetone, ethanol, and then distilled (DI) water.

Fourier-transform infrared absorption spectroscopy was performed using a Nicolet iS50 spectrophotometer (Thermo Fisher Scientific) operating in attenuated total reflectance (ATR) mode. The FTIR was installed with a GladiATR accessory (Pike Technologies) that is equipped with a diamond ATR crystal and a heating stage that allows measurement at temperatures up to 210° C. Water contact angle measurements on surfaces were acquired using a Ramé-Hart Model 260 goniometer.

FTIR spectra of WVO-modified silica fume were obtained. Absorption peaks of the aliphatic band (2970-2850 cm 1) and the ester carbonyl (1730 cm 1) are proof of deposition of WVO on the surface of the silica fume particles. The presence of the oil surface modification changes the surface of the Si-rich silica fume from being hydrophilic to hydrophobic. As a qualitative test, samples of modified fume were compressed into small pucks, and a 5 μL droplet of water was placed on each one. The water droplet remained beaded on the WVO-modified Si-rich fume, demonstrating its hydrophobicity. However, the WVO-modified Fe-rich fume still appeared hydrophilic. Closer examination of the FTIR spectra shows that although oil treatment of the Fe-rich silica deposited a significant amount of organic material as evidenced by the aliphatic peaks, the large peak at 1580 cm⁻¹ indicated the presence of ionized carboxylate groups (COO) overlapping a weak silica absorption band around the same wavenumber. The ionized carboxylate groups are due to cleavage of the triglyceride ester by alkaline minerals in the Fe-rich fume, specifically MgO (Table 1). To confirm this, some Fe-rich silica fume was neutralized with 0.5 M hydrochloric acid (HCl) and then rinsed and dried before being subjected to oil modification. The acid-neutralized Fe rich fume after modification with WVO was hydrophobic and no longer showed the strong carboxylate peak in the FTIR spectrum.

Aliphatic peaks in FTIR spectra of Si-rich silica fume treated with WVO under different reaction temperatures and after different washing procedures were compared. The strength of the aliphatic absorption peak was used as a rough indicator of the amount of matter deposited on the silica particles as a result of the oil treatment. Although most experiments were performed with 30 min reaction time, even 10 min of reaction time yielded positive results. Reaction temperature of 200 or 250° C. yielded similar results, but 150° C. was insufficient. Three cycles of solvent washing (two acetone cycles and one ethanol cycle) appeared sufficient to remove excess oil. Four washing cycles showed no further decrease in the aliphatic peak. There was still some residual unbound oil in the sample after two washing cycles.

By virtue of its high surface area, the silica fume also contained some adsorbed water. This adsorbed water does not appear to affect the modification process as silica fume that was dried at 170° C. for 1 h before treatment showed no difference in oil deposition by FTIR. The addition of 5 wt % Fe₃O₄ powder to the Si-rich silica fume nominally appears to increase oil deposition. This result hints at the possibility that iron oxide could help catalyze the deposition reaction, although some of the increase could also be due to the greater surface area-to-volume ratio of the smaller iron oxide particles (50 nm) than the silica fume (˜400 nm). Further study is required to elucidate any effect iron oxide might have on the reaction.

Table 3 lists iodine values estimated from FTIR for WVO, coconut oil, and linseed oil. Iodine value is directly proportional to the number of unsaturated ethylene groups in the oil, and it is thought that crosslinking of the triglyceride molecules occurs primarily at or around these carbon-carbon double bonds. Higher iodine value may lead to a thicker, more cross-linked hydrophobic coating. FTIR aliphatic absorption bands for Si-rich silica fume treated with each of the three oils were compared. The linseed oil turned out to be so reactive with the silica fume that the reaction was uncontrollable at 200° C., so a sample was reacted at 120° C. instead. Even at this low temperature, some modification of the surface with linseed oil was observed. Coconut oil is highly saturated, yet deposition of this oil on silica surfaces was also possible.

TABLE 3
Estimated iodine value of bio-oils

| Bio-oil | Iodine Value (g I₂/100 g) |
|---|---|
| WVO | 134.4 |
| Coconut | 35.6 |
| Linseed | 195.9 |

All three oils were used to treat large pieces of glass microscope slides successfully at 200° C. After rinsing off excess oil, the water contact angle on glass treated with WVO or linseed oil was around 83° whereas that for the glass treated with coconut oil was 79°. The hydrolytic stability of the oil treatment was then challenged by immersing the glass samples in warm water for 10 min at a time. After 10 min in water at 90° C., the contact angle of each sample decreased by 8-11°. The contact angle of the glass treated with coconut oil was consistently lower, suggesting a less durable coating. Linseed oil and WVO performed similarly to each other, suggesting that increasing iodine value past a certain point did not improve the efficacy of the treatment. Contact angle measurements of oil-treated glass slides before and after hydrolysis in water for 10 min at different temperatures were expected to be similar to the results shown in FIG. 1.

WVO treatment was applied to other minerals including montmorillonite clay (MMT) and alumina (Al₂O₃). FTIR spectra of both minerals after modification of the powders with WVO were obtained. While hydrophobic modification was possible, the results were less consistent and repeatable than with silica fume. Alumina in the form of 3 μm powder was rendered hydrophobic by the treatment, but 50 nm powder was not and appeared to cleave the triglyceride ester. MMT powder was usually rendered hydrophobic by the treatment, but anomalous chemical signatures sometimes appeared, possibly due to solvent absorbed during washing.

Utilizing a heated ATR stage with continuous FTIR measurements, the progress of the reactions occurring in oil at high temperature can be monitored in real time. A plot of change in intensity of the cis-ethylene CH stretching peak at 3008 cm⁻¹ for a drop of WVO held at 200° C. monitored over a period of 60 min is expected to be similar to results shown in FIG. 2. When exposed to open air, the WVO drop hardened into a solid and the ethylene peak rapidly disappeared, indicative of oxygen-mediated cross-linking of the triglyceride molecules through the ethylene groups on the fatty acid chains. When the test was repeated with a glass coverslip place on top of the WVO droplet to restrict oxygen access to the oil, the droplet remained mostly liquid after 60 min. The ethylene peak in this case decreased much more slowly and appeared to require an induction time before ethylene consumption accelerated. When a small amount of Si-rich silica fume was included, the decrease in the ethylene peak was more consistent, suggesting that the presence of silica fume does have an effect on the nature and progress of chemical reactions in WVO at high temperature.

Differential FTIR spectra of WVO at 200° C. were obtained, showing the changes in absorption with wavenumber over time. The oil was covered from direct exposure to air and was heated with or without silica fume on the ATR stage. The spectra show that the presence of silica fume significantly affects the resulting chemical process. The fume appears to promote formation of aromatics (1600-1550 cm⁻¹ and 900-750 cm⁻¹) and possibly Si—O—C linkages (1100-1000 cm⁻¹) while suppressing oxidation of the oil somewhat (1300-1100 cm⁻¹; various C—O groups). While oxidative cross-linking is the fastest way to solidify the oil, the increase in oxygen content may be detrimental to hydrophobicity.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A method of modifying siliceous material, the method comprising:
combining siliceous material and bio-oil to yield a mixture; and
polymerizing the bio-oil in the mixture to yield hydrophobic siliceous material, wherein a hydrophobicity of the hydrophobic siliceous material exceeds a hydrophobicity of the siliceous material.

2. The method of claim 1, wherein the siliceous material comprises at least 10 wt % silica.

3. The method of claim 1, wherein the siliceous material comprises glass fibers, glass beads, glass powders, mineral fume, nano silica, clay, quartz, granite, sand, sandstone, or any combination thereof.

4. The method of claim 3, wherein the mineral fume comprises Na⁺ clay, Ca⁺ clay, glass, slag, bottom ash, incineration ash, fly ash, mine tailing, metal oxides, or any combination thereof.

5. The method of claim 4, wherein the metal oxides comprise alumina and iron oxide.

6. The method of claim 1, wherein the bio-oil comprises oil from animal sources, plant sources, or both.

7. The method of claim 6, wherein the bio-oil comprises waste vegetable oil.

8. The method of claim 6, wherein the bio-oil comprises linseed oil, olive oil, coconut oil, vegetable oil, or any combination thereof.

9. The method of claim 1, wherein the bio-oil comprises one or more allylic functional groups.

10. The method of claim 1, wherein the bio-oil has an iodine value in a range of 6 to 200.

11. The method of claim 1, wherein combining the siliceous material and the bio-oil to yield the mixture further comprises sealing the mixture and an oxygen-containing gas in a container.

12. The method of claim 1, wherein polymerizing the bio-oil comprises heating the mixture in a temperature range of 150° C. to 200° C.

13. The method of claim 12, wherein heating the mixture comprises heating the mixture for a length of time from 1 minute to 1 hour.

14. The method of claim 1, further comprising separating the hydrophobic siliceous material and excess bio-oil.

15. The method of claim 1, further comprising contacting the siliceous material with acid before combining the siliceous material and the bio-oil to yield the mixture.

16. The method of claim 15, further comprising contacting the siliceous material with carbonic acid before combining the siliceous material and the bio-oil to yield the mixture.

17. The method of claim 1, further comprising contacting the siliceous material with supercritical carbon dioxide before combining the siliceous material and the bio-oil to yield the mixture.

18. The method of claim 1, further comprising combining Fe₃O₄ with the mixture before polymerizing the bio-oil.

19. A composition comprising:
a multiplicity of hydrophobic particles, wherein each hydrophobic particle comprises a polymeric bio-oil-derived coating on a core comprising siliceous material, and
a hydrophobicity of the polymeric bio-oil-derived coating exceeds a hydrophobicity of the corresponding core.

20. The composition of claim 19, wherein the core comprises glass fibers, glass beads, glass powders, mineral fume, nano silica, clay, quartz, granite, sand, sandstone, or any combination thereof.

21. The method of claim 20, wherein the mineral fume comprises Na⁺ clay, Ca⁺ clay, glass, slag, bottom ash, incineration ash, fly ash, mine tailing, metal oxides, or any combination thereof.

22. The method of claim 21, wherein the metal oxides comprise alumina and iron oxide.

23. The composition of claim 19, wherein the bio-oil comprises oil from animal sources, plant sources, or both.

24. The composition of claim 19, wherein the bio-oil comprises waste vegetable oil.

25. The composition of claim 19, wherein the bio-oil comprises linseed oil, olive oil, coconut oil, vegetable oil, or any combination thereof.
